(19) United States
(12) Patent Application Publication
(10) Pub. No.: US 2003/0135760 A1
(43) Pub. Date: Jul. 17, 2003

(54) Access control unit, host apparatus, and computer product

(75) Inventors: Takeshi Miyamae, Kawasaki (JP); Yoshitake Shinkai, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/277,198

(22) Filed: Oct. 22, 2002

(30) Foreign Application Priority Data
Jan. 16, 2002 (JP) 2002-007322

(51) Int. Cl. G06F 11/30; H04L 9/00

(52) U.S. Cl. 713/201

(57) ABSTRACT

A plurality of host computers share a hard disk. Each host computer includes a common client that does not depend on the operating system of the host computer. An access control unit is connected to the common client of each host computer via a network and to the hard disk. The access control unit receives a request relating to file access from the host computers.

### BACKGROUND OF THE INVENTION

1) Field of the Invention

The present invention relates to a technology for sharing a hard disk by a plurality of computers.

2) Description of the Related Art

FIG. 9 is a block diagram which shows the configuration of a conventional shared file system. This shared file system includes a plurality of host computers 10₁ to 10ₙ that share one shared disk drive 30.

The host computer 10₁ has an operating system 12₁ that controls execution of an application program 11₁. The host computer 10₁ has a file access controller 13₁ that is connected to the shared disk drive 30 via an interface 20₁ and executes file access (read and write of the file) to the shared disk drive 30 under control of the operating system 12₁. The file access controller 13₁ and the interface 20₁ are developed exclusively for the operating system 12₁, and do not operate normally in any other operating system.

The host computer 10₂ has an operating system 12₂ that controls execution of an application program 11₂. The host computer 10₂ has a file access controller 13₂ that is connected to the shared disk drive 30 via an interface 20₂, and executes file access to the shared disk drive 30, under control of the operating system 12₂. The file access controller 13₂ and the interface 20₂ are developed exclusively for the operating system 12₂, and do not operate normally in any other operating system.

The host computer 10ₙ has an operating system 12ₙ that controls execution of an application program 11ₙ. The host computer 10ₙ has a file access controller 13ₙ that is connected to the shared disk drive 30 via an interface 20ₙ, and executes file access to the shared disk drive 30, under control of the operating system 12ₙ. The file access controller 13ₙ and the interface 20ₙ are developed exclusively for the operating system 12ₙ, and do not operate normally in any other operating system.

For example, when there is a read request for a file in the course of the execution of the application program 11₁ of the host computer 10₁, the operating system 12₁ issues a command to read the desired file from the shared disk drive 30 to the file access controller 13₁. The file access controller 13₁ makes an access to the shared disk drive 30 via the interface 20₁ and reads the desired file from the shared disk drive 30.

For example, when there is a write request for a file in the course of the execution of the application program 11₂ of the host computer 10₂, the operating system 12₂ issues a command to write the desired file in the shared disk drive 30 to the file access controller 13₂. The file access controller 13₂ makes an access to the shared disk drive 30 via the interface 20₂ and writes the desired file on the shared disk drive 30.

Thus, in the conventional shared file system, the file access controller and the interface are specific to the operating system. In other words, if there are different operating systems, then a file access controller and an interface for each operating system must be developed. This increases the cost of the system.

### SUMMARY OF THE INVENTION

It is an object of this invention to provide an access control unit, an access control program, a host apparatus, and a host control program, which can share a file at a low cost.

The access control unit according to one aspect of the present invention comprises a request receiver connected to a plurality of host apparatuses via an interface, the interface having a configuration that does not depend on an operating system of the host apparatuses. This request receiver receives a request relating to file access to a shared disk drive from the host apparatus. There is provided a processing execution unit that executes processing corresponding to the request.

The host apparatus according to another aspect of the present invention comprises an access control unit that executes file access control to a shared disk drive; an interface connected to the access control unit, the interface having a configuration that does not depend on an operating system; and a request unit that issues a request relating to the file access to the access control unit via the interface.

The computer programs according to still another aspect of the present invention realize the configuration of the access control unit and the host apparatus of the present invention.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram which shows the configuration of an embodiment of the present invention,

FIG. 2 is a flowchart which explains the operation of the embodiment,

FIG. 3 is a flowchart of the start processing shown in FIG. 2,

FIG. 4 is a flowchart of the mounting processing shown in FIG. 2,

FIG. 5 is a flowchart of the read/write processing shown in FIG. 2,

FIG. 6 is a flowchart of the file lock processing shown in FIG. 2,

FIG. 7 is a block diagram of a first modification of the embodiment,

FIG. 8 is a block diagram of a second modification of the embodiment, and

FIG. 9 is a block diagram of a conventional shared file system.

### DETAILED DESCRIPTIONS

An embodiment of the access control unit, the access control program, the host apparatus, and the host control program according to the present invention will now be explained in detail, with reference to the accompanying drawings.

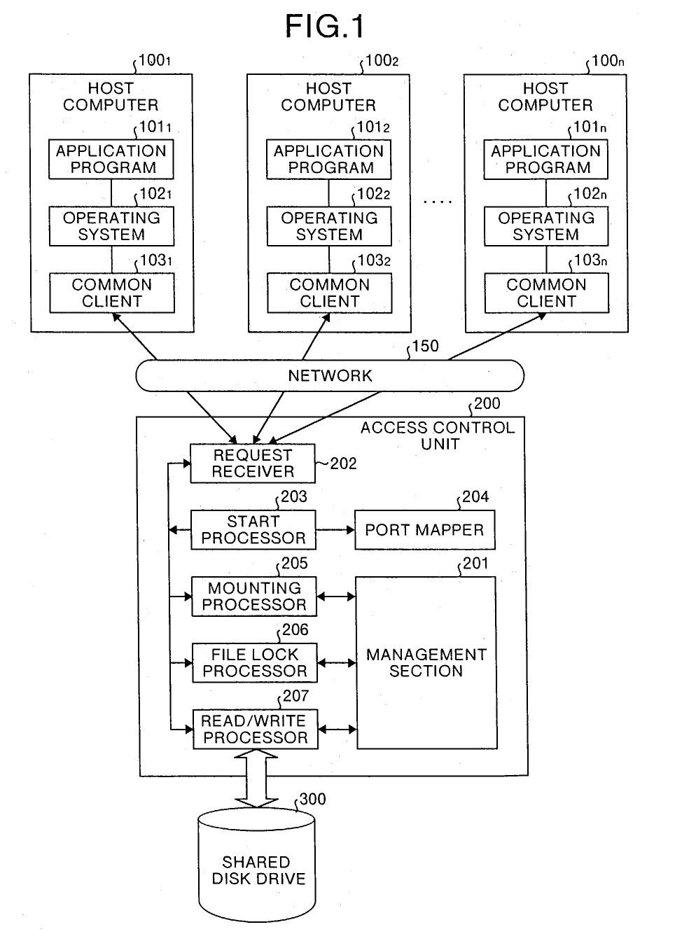

FIG. 1 is a block diagram which shows the configuration of the embodiment according to the present invention. This shared file system includes a plurality of host computers 100₁ to 100ₙ. Each of the host computers 100₁ to 100ₙ operate on a different operating system 102₁ to 102ₙ respectively, The host computers 100₁ to 100ₙ share a shared disk drive 300 via an access control unit 200.

In the host computer 100₁, the operating system 102₁ carries out execution control of an application program 101₁, and control of file access to the shared disk drive 300. The host computer 100₁ includes a client (common client) 103₁ that has same (common) specification for all kinds of operating systems. In other words, the specification of the common client) 103₁ does not depend on the operating system. The common client 103₁ issues an access request (e.g., mounting request, read/write request, file lock request) with respect to the shared disk drive 300 to the access control unit 200 via a network 150.

The mounting request is a request for mounting (grafting) a file path to another file path, relating to a file in the host computer 100₁. The read/write request is a request relating to read of a file from the shared disk drive 300, or write of a file in the shared disk drive 300. The file lock request is a request relating to locking of a file in the shared disk drive.

In the host computer 100₂, the operating system 102₂ carries out execution control of an application program 101₂, and control of file access to the shared disk drive 300. The host computer 100₂ includes a common client 103₂ that has a common specification with respect to all kinds of operating system, and does not depend on the operating system. The common client 103₂ issues an access request with respect to the shared disk drive 300 to the access control unit 200 via the network 150.

In the host computer 100ₙ, the operating system 102ₙ carries out execution control of an application program 101ₙ, and control of file access to the shared disk drive 300. The host computer 100ₙ includes a common client 103ₙ that has a common specification for any operating system, and does not depend on the operating system. The common client 103ₙ issues an access request (mounting request, read/write request, file lock request and the like) with respect to the shared disk drive 300 to the access control unit 200 via the network 150.

The access control unit 200 is accessed from the host computers 100₁ to 100ₙ via the network 150, and executes various processing relating to the shared disk drive 300, in response to the mounting request, read request, file lock request, and the like.

In the access control unit 200, a management section 201 executes file control in the shared disk drive 300. A request receiver 202 is connected to the common clients 103₁ to 103ₙ via the network 150, and receives mounting requests, read/write requests, file lock requests and the like.

Since the common clients 103₁ to 103ₙ have a common specification without depending on the operating system, the common clients 103₁ to 103ₙ and the request receiver 202 are controlled by a common communication protocol.

A start processor 203 executes processing at the time of starting the access control unit 200. A portmapper 204 executes control relating to the setting of ports between the host computers 100₁ to 100ₙ and the access control unit 200. A mounting processor 205 executes the mounting processing in response to a mounting request.

A file lock processor 206 executes file lock processing in response to a file lock request. A read/write processor 207 executes read/write processing in response to a read/write request. The shared disk drive 300 is a disk drive shared by the host computers 100₁ to 100ₙ.

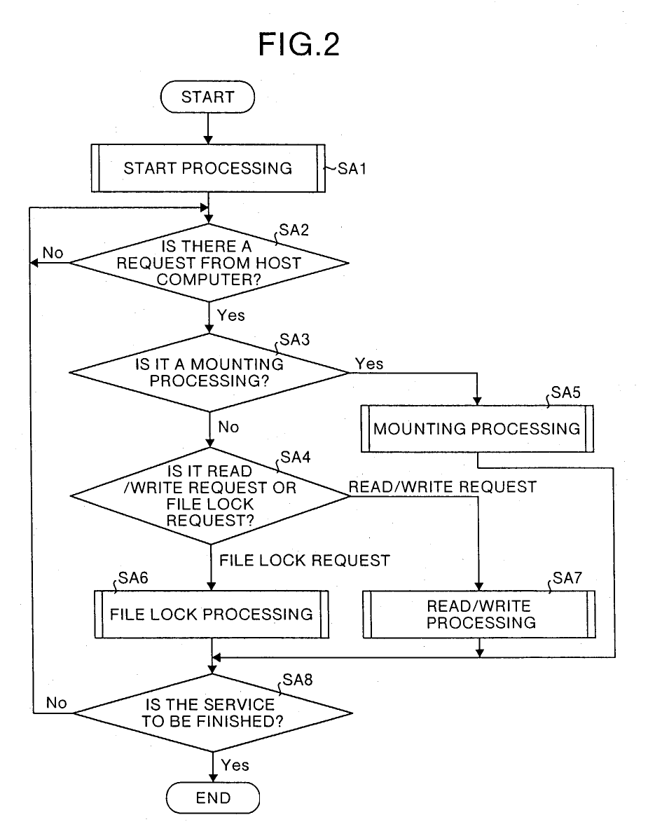

The operation of the shared system shown in FIG. 1 will be explained with reference to the flowcharts shown in FIG. 2 to FIG. 6. When an instruction to start the access control unit 200 is received from a user, at step SA1 shown in FIG. 2, the start processor 203 in the access control unit 200 executes a start processing.

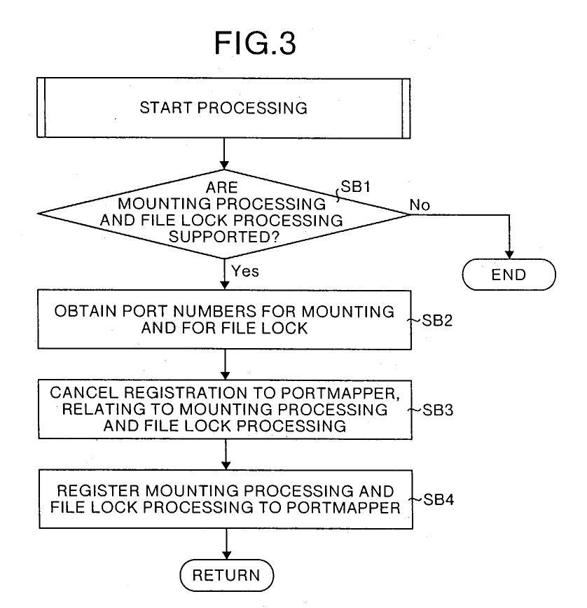

The start processing is explained in FIG. 3. At step SB1, the start processor 203 judges whether the access control unit 200 supports the mounting processing and the file lock processing, and when the judgment result is “No”, the start processor 203 finishes the start processing.

In this case, the start processor 203 judges “Yes” as the judgment result at step SB1. At step SB2, the start processor 203 obtains a port number for mounting and a port number for file lock from the portmapper 204.

At step SB3, the start processor 203 cancels registration to the portmapper 204 relating to the mounting processing and the file lock processing. At step SB4, the start processor 203 registers the mounting processing and the file lock processing to the portmapper 204.

Returning to FIG. 2, at step SA2, the request receiver 202 judges if there is a request, e.g., a mounting request, read/write request or file lock request, from any of the host computers 100₁ to 100ₙ. In this case, the request receiver 202 judges “No” as the judgment result, and repeats the judgment at step SA2.

For example, when there is a mounting request of a file in the course of the execution of the application program 110₁ of the host computer 100₁, the operating system 102₁ issues the mounting request to the common client 103₁.

Thereby, the common client 103₁ issues the mounting request to the request receiver 202 via the network 150. Then, the request receiver 202 judges “Yes” as the judgment result at step SA2 shown in FIG. 2.

At step SA3, the request receiver 202 judges whether the received request is amounting request, and in this case, it judges that the judgment result is “Yes”. At step SA5, the request receiver 202 makes a request to the mounting processor 205 to perform a mounting processing.

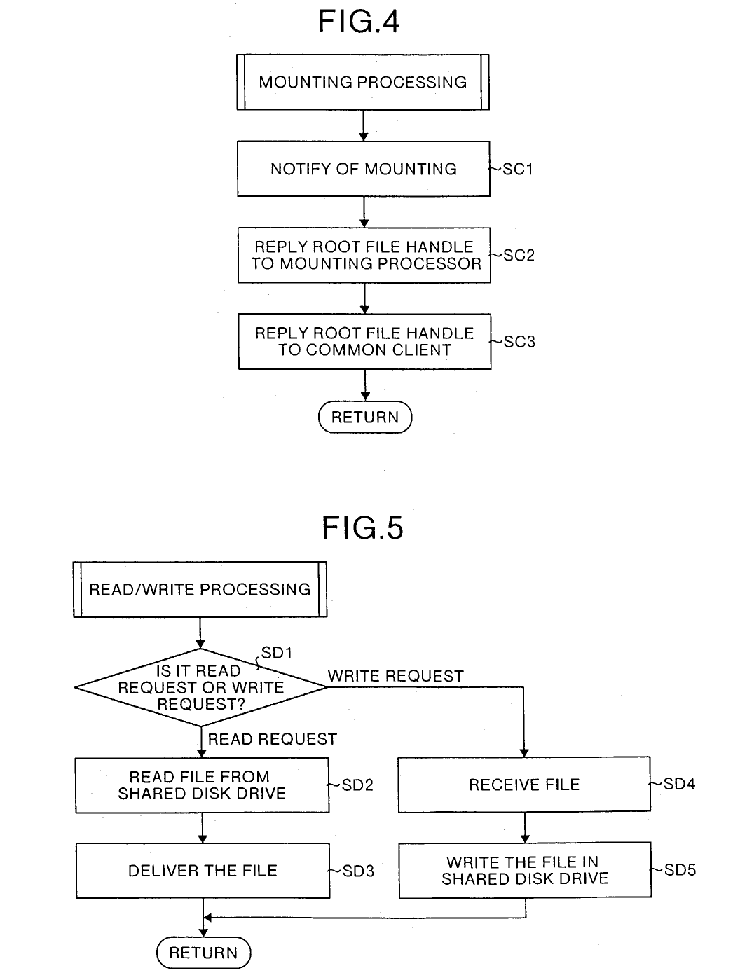

The mounting processing is explained in FIG. 4. At step SC1, the mounting processor 205 notifies the management section 201 of mounting. At step SC2, the management section 201 replies root file handle to the mounting processor 205. At step SC3, the mounting processor 205 replies root file handle to the common client 103₁ of the host computer 100₁ which has issued the mounting request.

For example, when there is a read/write request in the course of the execution of the application program 101₂ of the host computer 100₂, the operating system 102₂ issues the read/write request to the common client 103₂.

Thereby, the common client 103₂ issues the read/write request to the request receiver 202 via the network 150. Then, the request receiver 202 judges “Yes” as the judgment result at step SA2 shown in FIG. 2.

At step SA3, the request receiver 202 judges whether the received request is a read/write request, and in this case, it judges that the judgment result is “No”. At step SA4, the request receiver 202 judges whether the received request is the read/write request or the file lock request.

In this case, since the received request is a read/write request, at step SA7, the request receiver 202 makes a request to the read/write processor 207 to perform a read/write processing.

The read/write processing is explained in FIG. 5. At step SD1, the read/write processor 207 judges whether the received request is a read request or a write request. When the received request is the read request, at step SD2, the read/write processor 207 reads a file from the shared disk drive 300. At step SD3, the read/write processor 207 delivers the file to the host computer 100₂ that has made the request.

On the other hand, when the received request is a write request, at step SD4, the read/write processor 207 receives a file from the host computer 100₂ that has made the request. At step SD5, the read/write processor 207 writes the file in the shared disk drive 300.

For example, when there is a file lock request in the course of the execution of the application program 101ₙ of the host computer 100ₙ, the operating system 102ₙ issues the file lock request to the common client 103ₙ.

Thereby, the common client 103ₙ issues the file lock request to the request receiver 202 via the network 150. Then, the request receiver 202 changes the judgment result at step SA2 shown in FIG. 2 to “Yes”.

At step SA3, the request receiver 202 judges whether the received request is amounting request, and in this case, it judges that the judgment result is “No”. At step SA4, the request receiver 202 judges whether the received request is the read/write request or the file lock request.

In this case, since the received request is a file lock request, at step SA6, the request receiver 202 makes a request to the file lock processor 206 to perform a file lock processing.

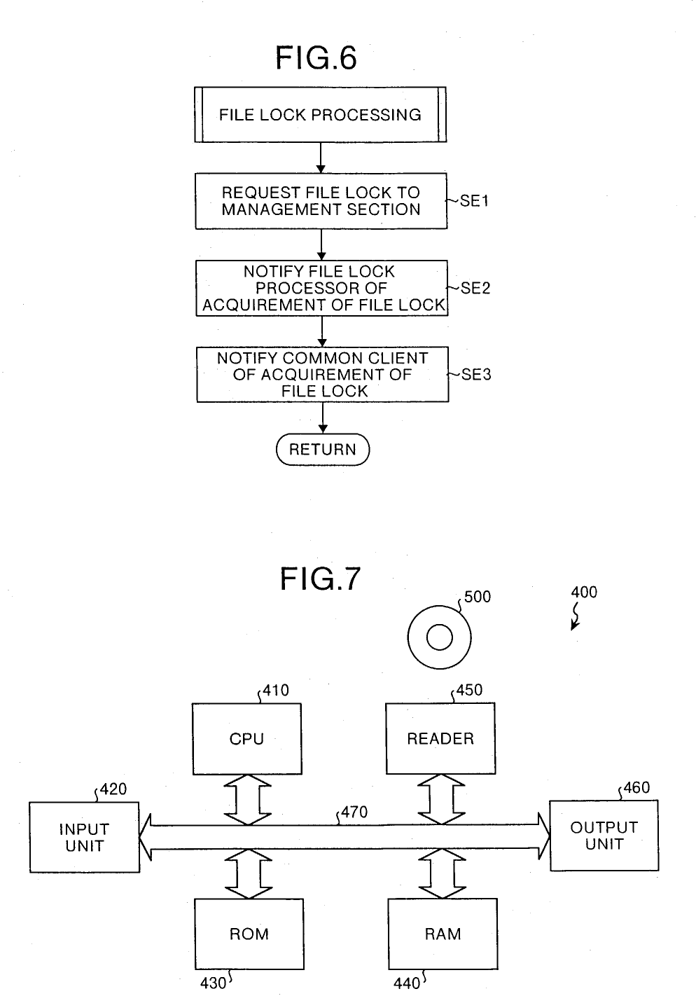

The file lock processing is explained in FIG. 6. At step SE1, the file lock processor 206 makes a request of file lock to the management section 201. At step SE2, the management section 201 notifies the file lock processor 206 of acquirement of a file lock. At step SE3, the file lock processor 206 notifies the common client 103ₙ of the host computer loon that has made the request of acquirement of the file lock. Returning to FIG. 2, at step SA8, it is judged whether end of the service is issued. Until the end of the service is issued, step SA2 and after are executed.

As explained above, according to the embodiment, the access control unit is connected to a plurality of host computers 100₁ to 100ₙ via the common clients 103₁ to 103ₙ and the request receiver 202 (interface) that do not depend on the operating system, and receives requests relating to file access to a shared disk drive 300 from the host computers, to thereby execute processing corresponding to the requests. As a result, it is not necessary to develop an interface for each operating system, and files can be shared at a low cost.

An embodiment of the present invention has been explained in detail with reference to the drawings, but specific configuration examples are not limited to this embodiment, and various design changes without departing from the scope of the present invention are included in the present invention.

For example, a computer program that realizes the file sharing function of the host computers 100₁ to 100ₙ or the access control unit 200 may be recorded in a computer readable recording medium 500 shown in FIG. 7. This computer program may be read and executed by a computer 400, to thereby realize the file sharing function.

The computer 400 shown in FIG. 7 comprises a CPU 410 which executes the program, an input unit 420 such as a keyboard, a mouse and the like, a ROM (Read Only Memory) 430 which stores various data, a RAM (Random Access Memory) 440 which stores arithmetic parameters and the like, a reader 450 which reads the program from the recording medium 500, an output unit 460 such as a display, a printer and the like, and a bus 470 which connects each section of the apparatus.

The CPU 410 reads the program recorded in the recording medium 500 via the reader 450, and executes the program, to thereby realize the file sharing function described above. The recording medium 500 includes a portable-type recording medium such as optical disks and flexible disks.

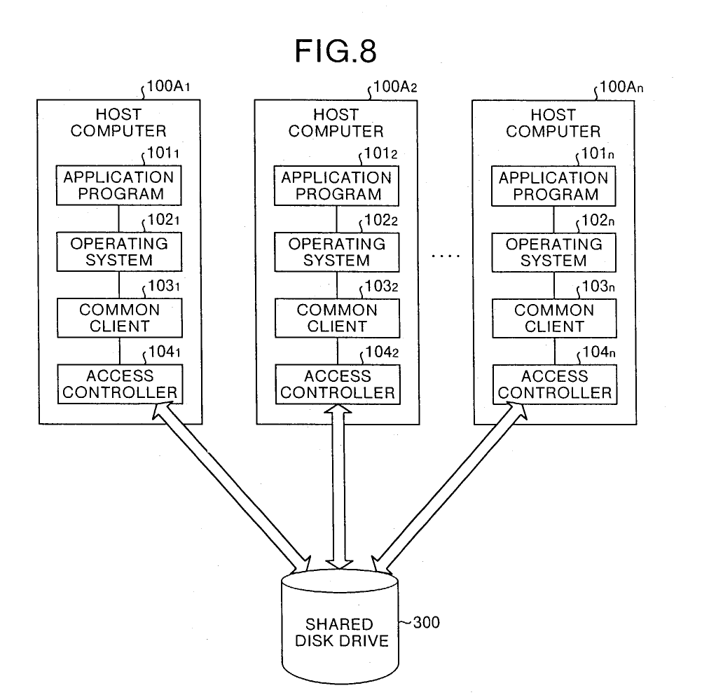

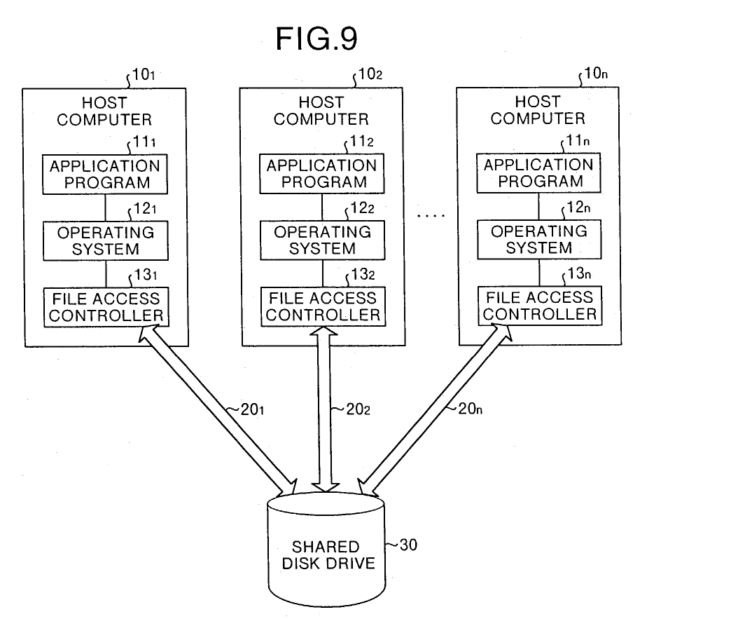

In FIG. 1, there has been explained a configuration example in which one access control unit 200 is shared by a plurality of host computers 100₁ to 100ₙ, but as shown in FIG. 8, the configuration may be such that the function of the access control unit 200 is included in the respective host computers 100A₁ to 100Aₙ.

In FIG. 8 the same reference symbols are provided to the portions corresponding to the respective sections in FIG. 1. In the host computers 100A₁ to 100Aₙ, each of the access controllers 104₁ to 104ₙ has the same function as that of the access control unit 200 (see FIG. 1). These access controllers 104₁ to 104ₙ are connected to the common clients 103₁ to 103ₙ via an interface that does not depend on the operating system.

According to the present invention, the access control unit is connected to a plurality of host apparatuses via an interface which does not depend on the operating system, and receives a request relating to file access to a shared disk drive from a host apparatus, to thereby execute processing corresponding to the request. Hence, there is the effect that it is not necessary to develop an interface for each operating system, and files can be shared at a low cost.

Moreover, there is the effect that mounting requests of files can be received at a low cost, without depending on the operating system.

Furthermore, there is the effect that file lock requests of files can be received at a low cost, without depending on the operating system.

Moreover, there is the effect that read/write requests of files can be received at a low cost, without depending on the operating system.

Furthermore, requests relating to file access to a shared disk drive are issued to the access control unit via an interface, which is connected to the access control unit which executes file access control to the shared disk drive and does not depend on the operating system. Hence, there is the effect that it is not necessary to develop an interface for each operating system, and files can be shared at a low cost.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An access control unit comprising:
a request receiver connected to a plurality of host apparatuses via an interface, the interface having a configuration that does not depend on an operating system of the host apparatuses, the request receiver receiving a request relating to file access to a shared disk drive from the host apparatus; and
a processing execution unit which executes processing corresponding to the request.

2. The access control unit according to claim 1, wherein the request includes a request for mounting a file.

3. The access control unit according to claim 1, wherein the request includes a request for locking a file.

4. The access control unit according to claim 1, wherein the request includes a request for reading/writing a file.

5. An access control program for allowing a computer to function as:
a request receiver connected to a plurality of host apparatuses via an interface, the interface having a configuration that does not depend on an operating system of the host apparatuses, the request receiver receiving a request relating to file access to a shared disk drive from the host apparatus; and
a processing execution unit which executes processing corresponding to the request.

6. A host apparatus comprising:
an access control unit that executes file access control to a shared disk drive;
an interface connected to the access control unit, the interface having a configuration that does not depend on an operating system; and
a request unit that issues a request relating to the file access to the access control unit via the interface.

7. A host control program for allowing a computer to function as:
an access control unit that executes file access control to a shared disk drive;
an interface connected to the access control unit, the interface having a configuration that does not depend on an operating system; and
a request unit that issues a request relating to the file access to the access control unit via the interface.
